(19) United States
(12) Patent Application Publication
(10) Pub. No.: US 2014/0189064 A1
(43) Pub. Date: Jul. 3, 2014

(54) METHOD AND SYSTEM FOR ADAPTIVE VIDEO TRANSMISSION

(71) Applicants: BRUCE R. CILLI, MURRAY HILL, NJ (US); CHARLES R. PAYETTE, MURRAY HILL, NJ (US)

(72) Inventors: BRUCE R. CILLI, MURRAY HILL, NJ (US); CHARLES R. PAYETTE, MURRAY HILL, NJ (US)

(21) Appl. No.: 13/731,236

(22) Filed: Dec. 31, 2012

(51) Int. Cl. H04L 29/06

(52) U.S. Cl. CPC H04L 65/60
USPC 709/219

(57) ABSTRACT

Systems, methods and apparatus for efficiently archiving variable quality streaming video by contemporaneously storing higher quality video stream segments and subsequently storing lower quality video stream segments via a backfilling process.

### CROSS-REFERENCE TO RELATED APPLICATIONS

This application is related to pending patent applications Ser. Nos. 12/702,722, filed Feb. 9, 2010, 12/793,213, filed Jun. 3, 2010 and 12/938,486, filed Nov. 3, 2010.

### FIELD OF THE INVENTION

The invention relates generally to communication networks, and more particularly to video transmission in such networks.

### BACKGROUND

Wireless access is a shared and limited resource where demand often outstrips supply. Video streaming from wireless devices is popular and generally dependent upon adaptive streaming techniques which stream video at whatever quality may be supported by the network. While often suitable for video presentation purposes, such adaptive streaming techniques may be insufficient for other purposes, such as archival storage and the like.

### SUMMARY

Various deficiencies in the prior art are addressed herein with systems, methods and apparatus for efficiently archiving variable quality streaming video by contemporaneously storing higher quality video stream segments and subsequently storing lower quality video stream segments via a backfilling process.

A method for archiving streaming video according to one embodiment comprises: for ones of a sequence of video stream segments forming a video stream, performing the steps of: requesting a video stream segment at a first quality level determined in response to a transmission channel condition; receiving the video stream segment; forwarding the video stream segment to a presentation engine; storing the video stream segment if associated with at least a first threshold quality level; and repeating said requesting, receiving and storing the video stream segment if associated with less than the first threshold quality level.

### BRIEF DESCRIPTION OF THE DRAWINGS

The teachings herein can be readily understood by considering the following detailed description in conjunction with the accompanying drawings, in which:

FIG. 1 depicts an exemplary wireless communication system including an intermediary server according to an embodiment;

FIG. 2 depicts a flow diagram of a method for adaptive video transmission associated with streaming video according to one embodiment;

FIG. 3 depicts a flow diagram of a method for adaptive video transmission associated with archiving streaming video according to one embodiment; and

FIG. 4 depicts a high-level block diagram of a computer suitable for use in performing the functions described herein.

To facilitate understanding, identical reference numerals have been used, where possible, to designate identical elements that are common to the figures.

### DETAILED DESCRIPTION OF THE INVENTION

Embodiments of the invention will be primarily described within the context of adaptive bitrate streaming for video transmission associated with wireless network elements, communications links and the like. However, while primarily discussed within the context of managing video streaming associated with wireless network elements supporting mobile services within a wireless network or portions thereof, those skilled in the art and informed by the teachings herein will realize that the various embodiments are also applicable to wireless video resources associated with other types of wireless networks (e.g., LTE, 4G networks, 3G networks, 2G networks, WiMAX, etc.), wireline networks or combinations of wireless and wireline networks in which finite bandwidth resources may be managed. Thus, the network elements, links, connectors, sites and other objects representing mobile services may identify network elements associated with other types of wireless and wireline networks.

Wireless access is a shared limited resource and as demand outstrips supply such resource may become scarce. Video streaming from wireless devices to the network is becoming very popular and uses a large portion of the wireless resources. Various implementations of adaptive bitrate streaming have been developed because the video streaming experience depends greatly on varying bandwidth available over time on the wireless network and elsewhere. One common technique utilizes the available bandwidth and processor capabilities, and streams at an appropriate bitrate. The effect is that as the bitrate goes down, the quality of the video degrades gracefully; nevertheless, the degradation pattern continues. Traditionally, this has been the accepted approach for Content Delivery Networks (CDNs) to deliver video to end devices in the downlink (DL) direction. However, it can also be applied in the uplink (UL) direction. For instance, if the video user is capturing imagery on a wireless device and also wants to save the video in the network at the originally saved resolution and quality (frame rate, etc), the entire video has to be re-sent for archiving etc. wasting resources.

There are a number of implementations for adaptive bitrate video streaming for video. Most of these implementations utilize hypertext transfer protocol (http) but that is not a requirement. Some of the more widespread implementations are Apple Http Adaptive Streaming, Adobe Dynamic Streaming for Flash, and Microsoft Smooth Streaming. These and other implementations typically share a mechanism to provide the receiving client a playlist from which to select “chunks” or segments of video. The video receiver requests these segments based on the currently available bandwidth, processor resources, etc. These segments are typically of relatively short duration (e.g., 2 seconds). This video will not be received with the highest quality over the entire duration of the session, because the available bandwidth is likely to fluctuate over the course of the video streaming session. In other words, the quality of the received video stream is unacceptable for purposes of video archiving and the like. Thus, for video archiving, rather than re-transmitting the entire video and waste wireless resources, the video imagery that was already transmitted is utilized. The receiver can maintain all of the segments of video that it has received. Each individual segment will be at various levels of quality due to the changing transmission channel conditions during the course of the video streaming session.

In various embodiments, the video receiver saves these segments. To archive a high quality copy of the video, the receiver at a later time requests only those segments of video that it did not previously receive at the highest quality. This will eliminate the need to resend the entire video session, but only require resending those parts (i.e., segments) that were not transmitted at the highest quality. This process can be performed when wireless resources are underutilized to reduce pressure on the wireless resources. If the receiving or source client was originally over a cellular interface, the request for the “makeup” segments and the transmission of the segments could be over the cellular interface or over WiFi or over some other interface to further reduce pressure on the cellular air interface.

In other embodiments, the video receiver discards these segments when the session is over.

The various embodiments discussed herein are primarily discussed within the context of streaming video from one particular device towards another particular device. It will be appreciated that the inventors contemplate streaming video content or other content in either direction; namely, a mobile device may also comprise a video stream transmission device where streamed video content is presented/archived at a another mobile device or at a server.

Currently, the original video would be streamed from the wireless device. Later, if the wireless user wishes to have a higher quality version of the video session stored on the network, the user would have to send the entire video session over again at the highest quality. The high quality video sent at a later time can be transmitted in a non-streaming manner.

Wireless users are encouraged to consume less data and service providers better utilize the wireless resources now that service providers are limiting the bandwidth available to wireless users.

In various embodiments, methods are implemented to take advantage of some portion of the original video session that was originally streamed over the wireless medium. In these embodiments, those “segments” of video that were not sent at the higher quality are sent in the background.

Although the adaptive bitrate video transmission capability is primarily depicted and described herein within the context of wireless communications network, it will be appreciated that the adaptive bitrate video transmission capability may be used in any other suitable types of communication networks.

As used herein, the term “video” generally refers to encoded multimedia or video information (with or without corresponding audio information) such as captured by a video recording device associated with a mobile phone, computer or other communications device. This video or multimedia information is typically encoded according to any of a number of multimedia encoding/decoding, compression/decompression, transport or streaming protocols, such as AVI, MPEG, H.261 and the like. Similarly, the term “streaming” generally refers to substantially real time transmission or reception of a multimedia or video stream.

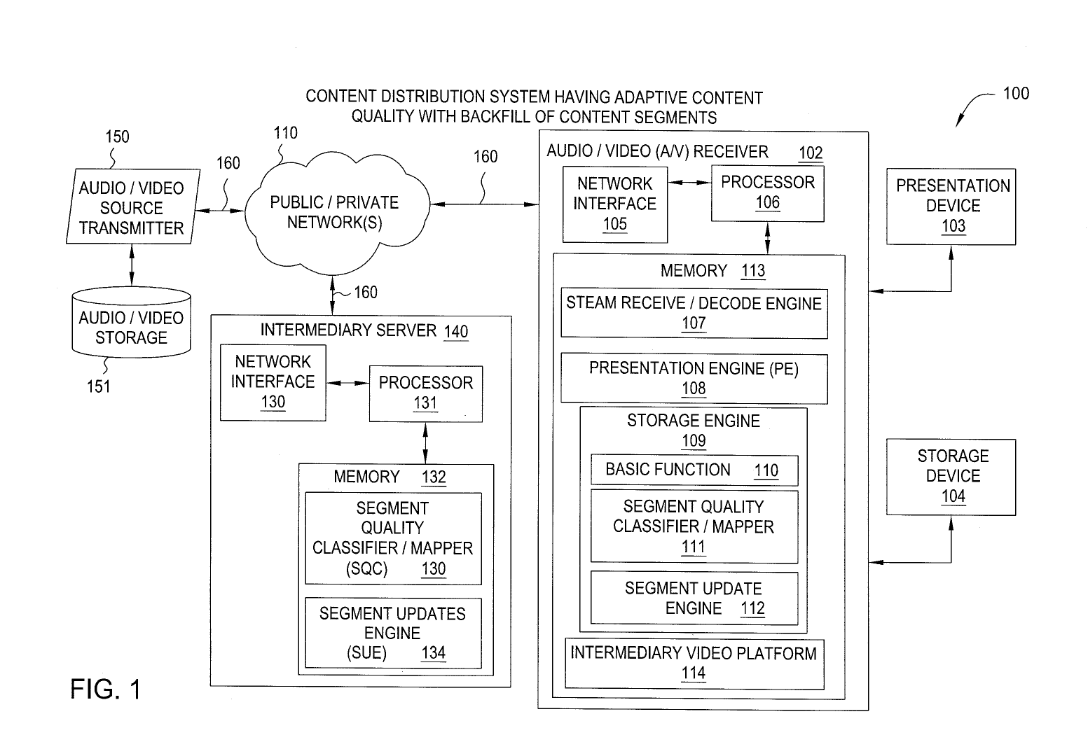

FIG. 1 depicts an exemplary wireless communication system including an intermediary server according to an embodiment. Specifically, FIG. 1 depicts an exemplary wireless communication system 100 that includes an audio/video (A/V) receiver 102, a public/private network 110, a presentation device 103, a storage device 104, an intermediary server 140, an A/V (audio/video) source transmitter 150, and A/V storage 151.

The public/private network 110 supports communications between the audio/video receiver 102, the audio/video source transmitter 150 and/or intermediary server 140, as well as various other network communication and/or management elements (not shown). The network interface 160 is adapted to facilitate communications with the different devices connected to public/private network 110.

A/V receiver 102 is a wireless user device capable of accessing a wireless network. A/V receiver 102 is capable of supporting control signaling in support of bearer session(s). A/V receiver 102 may be a phone, PDA, computer, or any other wireless user device.

The general configuration and operation of a public/private network will be understood by one skilled in the art. Various modifications to this configuration are known to those skilled in the art and are contemplated by the inventor as applicable to the various embodiments.

As depicted in FIG. 1, elements of network 110 communicate with each other via various interfaces. The interfaces described with respect to network 110 may also be referred to as sessions.

In various embodiments, the intermediary server 140 saves and passes the segments of video sessions onto receiver 102 when intermediary 140 is the intended location for the archival of high quality version of the video session. In these embodiments, while video receiver 102 plays the streamed varying quality video, intermediary server 140 also saves the segments. This intermediary server later recreates the high quality video by requesting the high quality segments to replace the low quality segments transmitted during the video streaming session.

The intermediary server 140 may be combined into or included within an element management system (EMS) or network management system (NMS). Similarly, the audio/video source transmitter 150 may be combined into or included within an element management system (EMS) or network management system (NMS)

Various embodiments provide for the implementation of the intermediary server. For example, in one embodiment, the intermediary server is implemented as standalone devices. In another embodiment, the intermediary server is implemented as an Intermediary Video Platform within the audio/video receiver.

Referring to FIG. 1, it will be assumed for purposes of this discussion that A/V receiver 102 functions as a destination user device. In one embodiment, user A/V receiver 102 requests audio/visual content associated with A/V source transmitter 150. That is, the A/V source transmitter 150 captures audiovisual content via a built-in camera and streams the captured audiovisual content toward one or more destination A/V receiver 102 via wireless/wireline infrastructure. A/V source transmitter 150 may comprise or support content transmission via, illustratively Netflix, YouTube, Hulu and the like.

In various embodiments, audiovisual content is captured externally and loaded onto A/V source transmitter 150 for streaming.

While described herein in terms of source and destination smart phones or user devices, any internet-enabled device including a desktop computer, laptop computer, tablet computer, personal digital assistant (PDA), cellular telephone, wireless hotspot and the like capable of accessing the Internet may be used in terms of source and/or destination devices as described herein with respect to the various embodiments. Thus, while mobile phones are generally discussed within the context of the various embodiments, the use of any device having similar streaming functionality is considered to be within the scope of the present embodiments.

In operation, a wireless (or fixed audiovisual transmitter) A/V source transmitter 150 captures video imagery to be streamed to some A/V receiver 102 in the network. The wireless A/V source transmitter 150 uses some form of adaptive bit rate streaming to account for the varying wireless resources and resources in the network. In addition, wireless A/V source transmitter 150 also wants to archive a high quality copy of the video at the receiver at the original quality the video imagery was recorded.

The video imagery is streamed, but because of location in or movement of the A/V source transmitter 150 to areas of deteriorating signal conditions and available bandwidth, the receiving client will not always request “segments” of video imagery at the highest quality. The video receiver “detects” that the channel conditions between the A/V source transmitter 150 and the A/V receiver 102 are such that the A/V receiver 102 cannot support the higher quality segments. So, the A/V receiver 102 requests “segments” of lower quality that better match what the A/V receiver 102 perceives the current bandwidth and other resources available to be. The A/V video receiver 102 is still able to present imagery of acceptable quality. Later, the video receiver can get a high quality copy of the video session by requesting only those segments that A/V receiver 102 did not already receive at a high quality. The lower quality segments are thus replaced. This embodiment mainly addresses the situation where the A/V source transmitter is on a wireless network. In another embodiment, the A/V source transmitter is on a fixed network and the A/V receiver is on a mobile network. Disturbances occurring throughout the transmission channels affect the streaming session in the same manner as described above when the audiovisual source transmitter is mobile.

In various embodiments, such as where video captured at a mobile device is streamed toward the source transmitter, archiving may occur at audio/video storage 151.

In various embodiments, A/V receiver 102 receives an adaptive bitrate video stream from a video server in the network (e.g., Netflix, YouTube, etc). The original streamed video is viewed as it is streaming. These video segments are stored. Later the video session can be enhanced to the highest quality by only requesting those video segments that are not already at the highest quality. These requests could be over the original cellular interface or any other interface to which the video receiver can connect (WiFi, etc.). These segments that require higher quality replacement can even be requested as the video is being viewed a second time.

Although described with respect to these two embodiments, other arrangement within the context of providing a minimum level of video quality to the users may be implemented.

As depicted in FIG. 1, Audio/Video (A/V) Receiver 102 includes one or more processor(s) 106, a memory 113 and a network interface 105. The processor(s) 106 is coupled to each of the memory 113 and the network interface 105, which are adapted to cooperate with memory 113 and various support circuits to provide various bitrate adaptive functions for A/V receiver 102 such as described herein.

The memory 113, generally speaking, stores programs, data, tools and the like that are adapted for use in providing various bitrate adaptive functions for A/V receiver 102. The memory includes a Stream Receive/Decode Engine 107 (SRDE), a Presentation Engine 108 (PE), a Storage Engine (SE) 109, Basic function Engine 110, Segment Quality Classifier/Mapper (SQCM) 111, a Segment Update Engine 112 and an Intermediary Video Platform (IVP) 114.

The Stream Receive/Decode Engine 107 (SRDE) receives and decodes session data such as compressed video stream data received from the public/private network. The Presentation Engine 108 (PE) implements presentation related processes adapted to provide decoded and/or baseband audiovisual data to, illustratively, the presentation device 103 for subsequent audiovisual presentation to a user/viewer. The Storage Engine (SE) 109 implements storage/archival related processes adapted to archive high quality segments of a received video stream. The SE 109 includes a Segment Quality Classifier/Mapper (SQCM) 111 which determines the quality of a session segment, a Segment Update Engine 112 which obtains or attempts to obtain session segment data of a higher quality when that session segment data was initially received at a quality below a given threshold, and a basic function Engine 110 which performs other functionality for processing session segment data. The Intermediary Video Platform (IVP) 114 provides the functionality which enables interaction/s with intermediary server 140. In one embodiment, the IVP 114 is implemented as a standalone server operatively coupled to the various elements described below with respect to intermediary server 140.

In one embodiment, PE 108 is implemented using software instructions which may be executed by processor (e.g., processor(s) 106) for performing the various bitrate adaptive functions depicted and described herein. In another embodiment, PE 108 is implemented in presentation device 103. In this embodiment, PE 108 is then a simple interface between A/V receiver 102 and presentation device 103 operatively coupled to the various elements described herein.

In one embodiment, SE 109 is implemented using software instructions which may be executed by processor (e.g., processor(s) 106) for performing the various bitrate adaptive functions depicted and described herein. In another embodiment, SE 109 is implemented in storage device 104 operatively coupled to the various elements described herein. In this embodiment, SE 109 is then a simple interface between A/V receiver 102 and storage device 104.

In one embodiment, Segment Quality Classifier/Mapper (SQCM) 111 and Segment Update Engine 112 are implemented using software instructions which may be executed by processor (e.g., processor(s) 106) for performing the various bitrate adaptive functions depicted and described herein. The memory 113 stores data which may be generated by and used by various ones and/or combinations of the engines, functions and tools.

Although depicted and described with respect to an embodiment in which each of the engines are stored within memory 113, it will be appreciated by those skilled in the art that the engines may be stored in one or more other storage devices internal to A/V receiver 102 and/or external to A/V receiver 102. The engines may be distributed across any suitable numbers and/or types of storage devices internal and/or external to A/V receiver 102. The memory 113, including each of the engines of memory 113, is described in additional detail herein below.

As described herein, memory 113 includes the Stream Receive/Decode Engine 107 (SRDE), a Presentation Engine 108 (PE), a Storage Engine 109, Basic function Engine 110, Segment Quality Classifier/Mapper (SQCM) 111, a Segment Update Engine 112 and an Intermediary Video Platform (IVP) 114, which cooperate to provide the various functions depicted and described herein. Although primarily depicted and described herein with respect to specific functions being performed by and/or using specific ones of the engines of memory 113, it will be appreciated that any of the functions depicted and described herein may be performed by and/or using any one or more of the engines of memory 113.

As depicted in FIG. 1, intermediary server 140 includes one or more processor(s) 131, a memory 132 and a network interface 130. The processor(s) 131 is coupled to each of the memory 132 and the network interface 130, which are adapted to cooperate with memory 132 and various support circuits to provide various bitrate adaptive functions for intermediary server 140 such as described herein.

The memory 132, generally speaking, stores programs, data, tools and the like that are adapted for use in providing various bitrate adaptive functions for intermediary server 140 such as described herein. The memory includes a Segment Quality Classifier/Mapper 133 (SQC), a Segment Update Engine 134 (SUE).

In one embodiment, the SQC 133 and SUE 134 are implemented using software instructions which may be executed by processor (e.g., processor(s) 130) for performing the various bitrate adaptive functions depicted and described herein. The memory 132 stores data which may be generated by and used by various ones and/or combinations of the engines, functions and tools.

Although depicted and described with respect to an embodiment in which each of the engines are stored within memory 132, it will be appreciated by those skilled in the art that the engines may be stored in one or more other storage devices internal to intermediary server 140 and/or external to intermediary server 140. The engines may be distributed across any suitable numbers and/or types of storage devices internal and/or external to intermediary server 140. The memory 132, including each of the engines of memory 132, is described in additional detail herein below.

As described herein, memory 132 includes the SQC 133 and SUE 132 which cooperate to provide the various functions depicted and described herein. Although primarily depicted and described herein with respect to specific functions being performed by and/or using specific ones of the engines of memory 132, it will be appreciated that any of the functions depicted and described herein may be performed by and/or using any one or more of the engines of memory 132.

In other embodiments, the functions of intermediary server 140 are implemented using software instructions which may be executed by processor (e.g., processor(s) 130) for performing the various bitrate adaptive functions depicted and described herein.

In various embodiments, A/V source transmitter 150 communicates with A/V storage 151 to store, retrieve and propagate multimedia content toward intermediary server 140 and A/V receiver 102. As described herein, in some embodiments, A/V source transmitter 150 captures audiovisual content via a built-in camera and streams the captured audiovisual content toward one or more destination A/V receiver 102 via wireless/wireline infrastructure. A/V source transmitter 150 comprise Netflix, YouTube and the like. In other embodiments, audiovisual content is captured externally and loaded onto A/V source transmitter 150 for streaming.

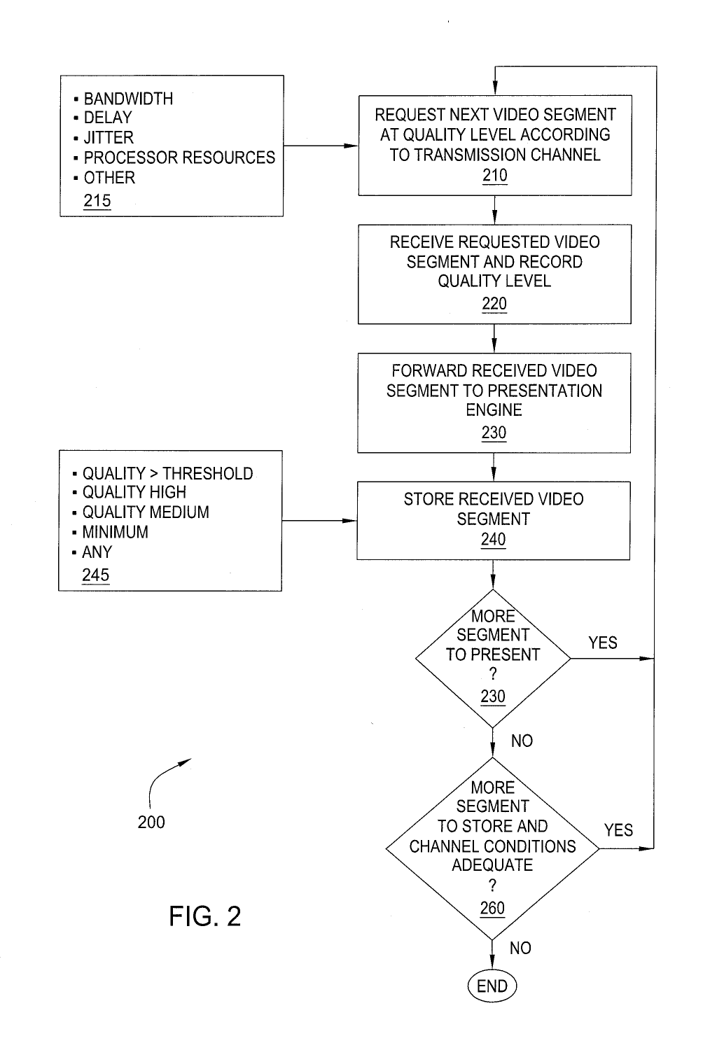

FIG. 2 depicts a flow diagram of a method for efficiently archiving streaming video according to one embodiment. Specifically, each of a sequence of video segments associated with a video stream is requested to be transmitted at a quality level appropriate to the transmission channel. These segments are typically of relatively short duration (e.g., one, two or three seconds). The received video segments will probably not be received at the highest quality over the entire duration of the session because the available bandwidth is likely to fluctuate over the course of the video stream session.

Generally speaking, a received video segment has associated with a quality level sufficient for presentation purposes, though not necessarily sufficient for archival or storage purposes. The method 200 of FIG. 2 depicts a primary loop (210-250) adapted to receive and process for presentation and archival purposes the sequence of video stream segments associated with a requested video stream. The method 200 of FIG. 2 depicts a secondary loop (210-260) in which those video stream segments previously processed for presentation and archival purposes having a quality level insufficient for archival purposes (though sufficient for presentation purposes) are requested to be retransmitted at a quality level sufficient for archival purposes.

At step 210, after any necessary session set up and the like (not shown), a request is propagated from a receiver towards a transmitter for a next video segment at a quality level determined with respect to transmission channel conditions. Referring to box 215, transmission channel conditions may comprise one or more of bandwidth availability, delay, jitter, processor resource constraints and/or other parameters or constraints relevant to determining an appropriate encoding quality level of a video segment to propagate for the transmission channel. In various embodiments, A/V receiver 102 requests video imagery from A/V source transmitter 150. In various embodiments A/V receiver 102 probes (e.g., detects through its rate determination algorithm (RDA) or some other mechanism) the current channel(s) conditions to determine whether or not the communications channel(s) conditions are adequate to support the highest quality video transmission.

At step 220, the requested video segment is received and its quality level is determined/recorded (if not already determined/recorded). In one embodiment, A/V receiver 102 receives segments of requested video imagery. In various embodiments, A/V receiver 102 determines the quality of received video segments. The received segments are saved and identified. In some embodiment, a map is used to keep track of the received segments. In various embodiments, arrangement such as FIFO (first in/first out) memory buffer is used to record and identify the received segments of the session.

At step 230, the received video segment is forwarded to the presentation engine or other presentation circuitry. As described above, the presentation of the video segments is dependent upon the embodiment implemented. As discussed above, in one embodiment, Presentation Engine (PE) 108 is implemented using software instructions which may be executed by processor (e.g., processor(s) 106) for performing the various bitrate adaptive functions depicted and described herein. In another embodiment, PE 108 is implemented in presentation device 103. In this embodiment, PE 108 is then a simple interface between A/V receiver 102 and presentation device 103 operatively coupled to the various elements described herein.

At step 240, the received video segment is stored for archival purposes. Referring to box 245, the received video segment may be stored if it has a quality level at or exceeding a threshold quality level, if it has a high quality level, if it has a medium quality level, if it has a minimum quality level if it has any quality level (i.e., any received segment is stored).

At step 250, a query is made as to whether there are more segments within the sequence of video stream segments to be presented. If the query at step 250 is answered affirmatively (i.e., video stream not fully presented), then the method proceeds to step 210 where the next video segment to be presented is requested as previously discussed. If the query at step 250 is answered negatively (i.e., the video stream fully presented), then the method 200 proceeds to step 260. In various embodiments, A/V receiver 102 checks for the end of the video stream.

At step 260, a query is made as to whether more video segments are to be stored and, further, whether transmission channel conditions are adequate. That is, a query is made as to whether each video segment of a session of an appropriate quality level has been stored at step 240. If the query at step 260 is answered affirmatively (e.g., channel conditions adequate and more segments to be stored), then the method proceeds to step 210 where the next video segment to be stored is requested as previously discussed. If the query at step 260 is answered negatively, then the method exits. In various embodiments, A/V receiver 102 probes the current channel(s) conditions to determine whether or not the communications channel(s) conditions are adequate to support the highest quality video transmission.

Generally speaking, various embodiments may also operate to backfill video segments that were transmitted and received at a lower bitrate with video segments transmitted at a higher bit rate. Within the context of the backfill operation, the specific channel conditions are less important since real-time transmission is not necessary. That is, the previously received lower bit rate video segments were transmitted as part of a real time video stream having a primary purpose of real-time presentation of the underlying video content. By contrast, the backfill video segments may be transmitted on a non-real-time basis or real-time basis, since contemporaneous presentation is not necessary; all that is required is to receive and store the higher bit rate video segments for archival purposes and the like as discussed herein. Thus, channel conditions adequate to support retransmission of video segments for backfill/archival purposes do not necessarily require high bandwidth capability sufficient to support high data rate presentation.

The above-described method operates to present received video segments in sequence and at a quality level determined in response to substantially instantaneous transmission channel capabilities/parameters. The above-described method further operates to store received video segments at a quality level appropriate for archival purposes, such as a high quality level or some other quality level. A map or other mechanism may be used to track which segments have been stored at the archival quality level such that those segments not stored at the archival quality level are subsequently requested and received at the archival quality level.

It is noted that steps 250 in 260 are presented in a particular sequence. However, these steps may be combined in several ways as contemplated by the inventors. In particular, as transmission channel capacity improves such as due to improved bandwidth, reduced delay or jitter and the like, requests for archival quality segments may be opportunistically inserted or nested within the normal sequence of video segment requests.

Generally speaking, the above-described methodology advantageously utilizes those sufficiently high quality or archival quality segments received for presentation for the additional purpose of archival storage. In this manner, resources associated with repeating the request, receive and storage steps are conserved.

Although described with respect to one type of bitrate adaptive video transmission, other types of bitrate adaptive transmission within the context of the embodiments herein described may be implemented.

Although primarily depicted and described hereinabove with respect to an embodiment in which bitrate adaptive video streaming capability is provided by using a combination of application software installed on users devices and an intermediary server, it will be appreciated that in other embodiments only the intermediary server may be used or only the different engines using software instructions which may be executed by processor (e.g., processor(s) 106) for performing the various bitrate adaptive functions depicted and described herein are implemented.

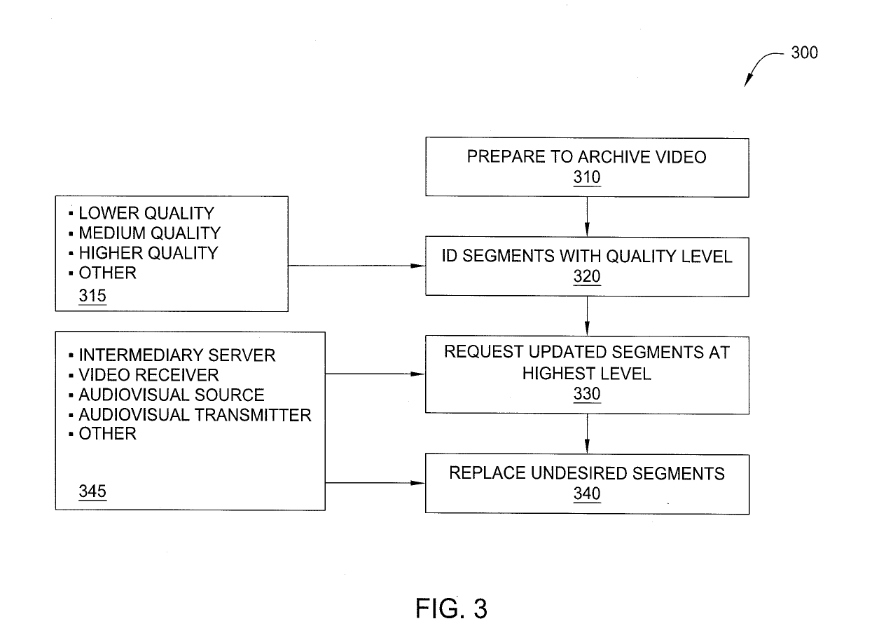

FIG. 3 depicts a flow diagram of a method for adaptive video transmission associated with archiving streaming video according to one embodiment.

At step 310, a user/device prepares to archive a video of interest.

At step 320, the stored segments are identified. Referring to box 315, in various embodiments, the operation identifies the quality level associated with each saved video segment. The segments are segregated according to respective quality level associated with each segment. The quality level spans the spectrum from lower to highest quality level. The particular delineation between quality levels will depend on appropriate thresholds.

At step 330, higher quality segments are requested.

At step 340, the low quality segments received during the video streaming session are replaced with the requested higher quality segments. Referring to box 345, in one embodiment, intermediary server 140 is the intended location for the archival of high quality version of the video. While video receiver 102 plays the streamed varying quality video, intermediary server 140 also saves the chunks. This intermediary server 140 later can recreate the high quality video by requesting the high quality chunks to replace the low quality chunks during the video streaming session. In another embodiment, A/V receiver 102 performs the archival of the session.

In various embodiments, A/V source transmitter 150 performs the archival process. In various embodiments, wireless audio/video receiver 102 receives an adaptive bitrate video stream from audio/video source transmitter 150 in the network (e.g. Netflix, YouTube, etc). The original streamed video is viewed as it is streaming. These video segments are stored. Later the video can be enhanced to the highest quality by requesting only those video segments that are not already at the highest quality. These requests could be over the original cellular interface or any other interface to which the audio/video receiver 102 can connect (WiFi, etc.).

In another embodiment, these segments that require replacement at the higher quality are requested as the video is being viewed a second time.

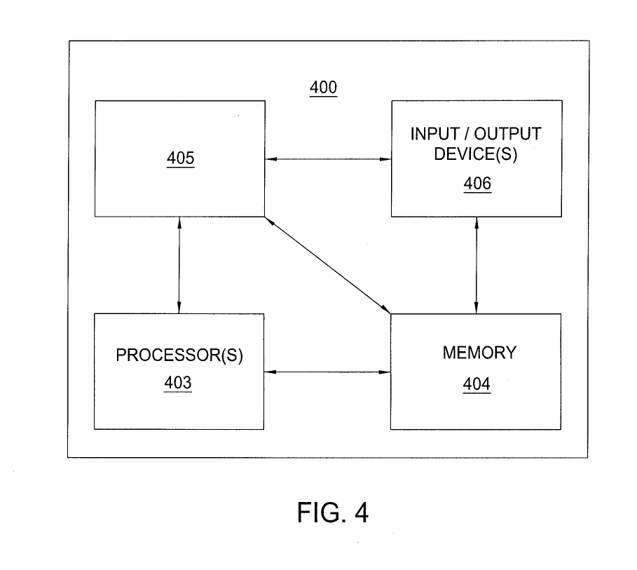

FIG. 4 depicts a high level block diagram of a computer suitable for use in performing functions described herein. As depicted in FIG. 4, computer 400 includes a processor element 403 (e.g., a central processing unit (CPU) and/or other suitable processor(s)), a memory 404 (e.g., random access memory (RAM), read only memory (ROM), and the like), a cooperating module/process 405, and various input/output devices 406 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in a combination of software and hardware, e.g., using a general purpose computer, one or more application specific integrated circuits (ASIC), and/or any other hardware equivalents. In one embodiment, the cooperating process 405 can be loaded into memory 404 and executed by processor 403 to implement the functions as discussed herein. Thus, cooperating process 405 (including associated data structures) can be stored on a computer readable storage medium, e.g., RAM memory, magnetic or optical drive or diskette, and the like.

It will be appreciated that computer 400 depicted in FIG. 4 provides a general architecture and functionality suitable for implementing functional elements described herein or portions network of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

While the foregoing is directed to various embodiments of the present invention, other and further embodiments of the invention may be devised without departing from the basic scope thereof. As such, the appropriate scope of the invention is to be determined according to the claims.

What is claimed is:

1. A method for archiving streaming video, comprising:
for ones of a sequence of video stream segments forming a video stream, performing the steps of:
requesting a video stream segment at a first quality level determined in response to a transmission channel condition;
receiving the video stream segment;
forwarding the video stream segment to a presentation engine;
storing the video stream segment if associated with at least a first threshold quality level; and
repeating said requesting, receiving and storing the video stream segment if associated with less than the first threshold quality level.

2. The method of claim 1, further comprising determining a quality level for the video stream segment received.

3. The method of claim 1, wherein the ones of the sequence of video stream segments forming a video stream are associated with a respective map entry indicative of quality level.

4. The method of claim 1, wherein said transmission channel condition comprises an available transmission channel bandwidth, a transmission channel delay, a transmission channel jitter or a processor resource condition.

5. The method of claim 1, wherein the presenting step further comprises storing the plurality of received segments of video streams further comprising presenting the video stream segment received.

6. The method of claim 1, wherein said quality level determined in response to the transmission channel condition comprises one of a high quality level and a low quality level, said first threshold quality level is said high quality level.

7. The method of claim 1, wherein said quality level determined in response to the transmission channel condition comprises one of a high quality level, a medium quality level and a low quality level, said first threshold quality level is said high quality level.

8. The method of claim 1, wherein said quality level determined in response to the transmission channel condition comprises one of a high quality level, a medium quality level and a low quality level, said first threshold quality level is said medium quality level.

9. The method of claim 1, further comprising performing the method for a plurality of video stream segments forming the video stream.

10. The method of claim 9, wherein said repeating of said requesting, receiving and storing the video stream segment is opportunistically performed in response to said transmission channel condition supporting requesting the video stream segment at said first threshold quality level.

11. The method of claim 10, wherein said transmission channel condition supporting requesting the video stream segment at said first threshold quality level comprises a transmission channel condition insufficient to support real time video stream delivery.

12. The method of claim 1, wherein said receiving and storing of the ones of the video stream segments is performed at a mobile device.

13. The method of claim 1, wherein said receiving and storing of the ones of the video stream segments is performed at an intermediary server.

14. The method of claim 1, wherein receiving and storing of the ones of the video stream segments is performed at an intermediary server, said intermediary server forwarding the ones of the video stream segments to a mobile device including a presentation engine.

15. The method of claim 13, wherein said intermediary server operates to archive video stream segments associated with a plurality of mobile devices.

16. The method of claim 13, wherein said intermediary server includes a segment quality classifier adapted to classify a quality level associated with the ones of the video stream segments passing therethrough.

17. The method of claim 15, wherein said intermediary server includes a segment update engine adapted to request retransmission of stored video segments having an insufficient quality level.

18. An apparatus, comprising a processor configured for:
for ones of a sequence of video stream segments forming a video stream, performing the steps of:
requesting a corresponding first video stream segment at a first quality level determined in response to a transmission channel condition;
receiving the corresponding first video stream segment;
forwarding the corresponding first video stream segment to a presentation engine;
storing the corresponding first video stream segment if associated with at least a first threshold quality level; and
repeating said requesting, receiving and storing the corresponding first video stream segment if associated with less than a first threshold quality level.

19. A tangible and non-transient computer readable storage medium storing instructions which, when executed by a computer, adapt the operation of the computer to provide a method, comprising:
for ones of a sequence of video stream segments forming a video stream, performing the steps of:
requesting a corresponding first video stream segment at a first quality level determined in response to a transmission channel condition;
receiving the corresponding first video stream segment;
forwarding the corresponding first video stream segment to a presentation engine;
storing the corresponding first video stream segment if associated with at least a first threshold quality level; and
repeating said requesting, receiving and storing the corresponding first video stream segment if associated with less than the first threshold quality level.

20. A computer program product wherein computer instructions, when processed by a computer, adapt the operation of the computer to provide a method, comprising:
for ones of a sequence of video stream segments forming a video stream, performing the steps of:
requesting a video stream segment at a first quality level determined in response to a transmission channel condition;
receiving the video stream segment;
forwarding the video stream segment to a presentation engine;
storing the video stream segment if associated with at least a first threshold quality level; and
repeating said requesting, receiving and storing the video stream segment if associated with less than the first threshold quality level.
